(19) United States
(12) Patent Application Publication
(10) Pub. No.: US 2009/0284680 A1
(43) Pub. Date: Nov. 19, 2009

(54) LIQUID CRYSTAL DISPLAY DEVICE AND METHOD FOR REPAIRING BROKEN LINES THEREOF

(76) Inventor: Zhilong PENG, Beijing (CN)

Correspondence Address: LADAS & PARRY LLP, 224 SOUTH MICHIGAN AVENUE, SUITE 1600, CHICAGO, IL, 60604, US

(21) Appl. No.: 12/427,068

(22) Filed: Apr. 21, 2009

(30) Foreign Application Priority Data
May 16, 2008 (CN) 200810111881.9

(51) Int. Cl. G02F 1/1343; G02F 1/13

(52) U.S. Cl. 349/55; 349/192

(57) ABSTRACT

An embodiment of the invention provides a method for repairing a broken signal line of a liquid crystal display device, comprising determining a position of a breaking point on the broken signal line and a pixel where the breaking point is located on an array substrate; and welding two parts of the broken signal line at both sides of the breaking point to a pixel electrode of the pixel by laser welding and disabling a thin film transistor as a switching device of the pixel by laser cutting. Also, there is provided a liquid crystal display device.

### BACKGROUND OF THE INVENTION

The invention relates to a liquid crystal display (LCD) device and a method for repairing broken lines.

Liquid crystal display (LCD) devices, which are of small volume, light weight, low power consumption and free of radiation, have prevailed in the market of flat panel display devices. Generally, a LCD device comprises a thin film transistor (TFT) array substrate and a color filter substrate, which are positioned in parallel with a gap therebetween. Interposed between the TFT array substrate and the color filter substrate is a liquid crystal material layer that can change its optical characteristics in response to an applied electrical field. On the array substrate, gate lines are provided for transmitting scan signals, data lines are provided for transmitting data signals, and pixel electrodes are formed for each pixel.

A typical method for manufacturing a LCD device comprises an array process of forming the array substrate and the color filter substrate, a cell process of attaching together the array substrate and the color filter substrate with a space therebetween and injecting liquid crystal materials into the space, and subsequent assembling processes. During the manufacturing, failures of pixels and signal lines are the main defects and mostly occur after the end of the array process. When the failures occur, a repair step is needed.

If the failures are found before the cell process, a defective pixel can be repaired by welding upper and lower plates of its storage capacitor with each other or welding a gate electrode to a drain electrode through laser irradiation, and defective lines may be repaired by forming a bridge through a chemical vapor deposition (CVD) repair method.

In practice, failures of pixels and signal lines may occur after the cell process. In this case, for defective pixels, a method of repairing by laser welding after the cell process is proposed. Specifically, by use of heat generated from laser, upper and lower plates of the storage capacitor in a defective pixel are welded with each other, or in the defective pixel a gate electrode is welded to a drain electrode, such that the defective pixel is repaired to be a dark spot. This is a typical method for repairing defective pixels from outside the LCD cell. However, for defective lines, there are still no workable methods. In industry, products having broken signal lines are generally discarded, which brings about great waste and increases the producing cost.

### SUMMARY OF THE INVENTION

An embodiment of the invention provides a method for repairing a broken signal line of a liquid crystal display device, comprising determining a position of a breaking point on the broken signal line and a pixel where the breaking point is located on an array substrate; and welding two parts of the broken signal line at both sides of the breaking point to a pixel electrode of the pixel by laser welding and disabling a thin film transistor as a switching device of the pixel by laser cutting.

Another embodiment of the invention provides a liquid crystal display device comprising an array substrate and a color filter substrate facing each other with a liquid crystal layer therebetween, the array substrate including a plurality of pixel regions defined by gate lines and data lines intersecting with each other, each pixel region including a pixel electrode and a thin film transistor as a switching device, wherein at least one pixel region is a repair region where a signal line breaking failure is repaired to become a pixel failure.

Further scope of applicability of the invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from the following detailed description.

### BRIEF DESCRIPTION OF THE DRAWINGS

The invention will become more fully understood from the detailed description given hereinafter and the accompanying drawings which are given by way of illustration only, and thus are not limitative of the invention and wherein:

FIG. 1 is a flow chart showing a method for repairing broken lines of a liquid crystal display device according to an exemplary embodiment of the invention;

FIG. 2 is a schematic view showing a broken gate line in a first exemplary embodiment of the invention;

FIG. 3 is a sectional view taken along a line A-A in FIG. 2;

FIG. 4 is a schematic view showing welding points according to the first exemplary embodiment of the invention;

FIG. 5 is a sectional view taken along a line B-B in FIG. 4;

FIGS. 6-8 are schematic views each showing a disabled thin film transistor according to the first exemplary embodiment of the invention;

FIG. 9 is a schematic view showing a broken storage electrode line in a second exemplary embodiment of the invention;

FIG. 10 is a schematic view showing welding points according to the second exemplary embodiment of the invention; and

FIG. 11 is a sectional view taken along a line C-C in FIG. 10.

### DETAILED DESCRIPTION OF THE PREFERRED EMBODIMENTS

Embodiments of the invention will be described more fully hereinafter with reference to the accompanying drawings.

FIG. 1 is a flow chart showing a method for repairing broken lines of a LCD device according to an exemplary embodiment of the invention. The method comprises determining the position of a breaking point on a broken signal line and the pixel where the breaking point is located; and welding two parts of the broken signal line at both sides of the breaking point to the pixel electrode of the pixel by laser welding and disabling the thin film transistor of the pixel by laser cutting.

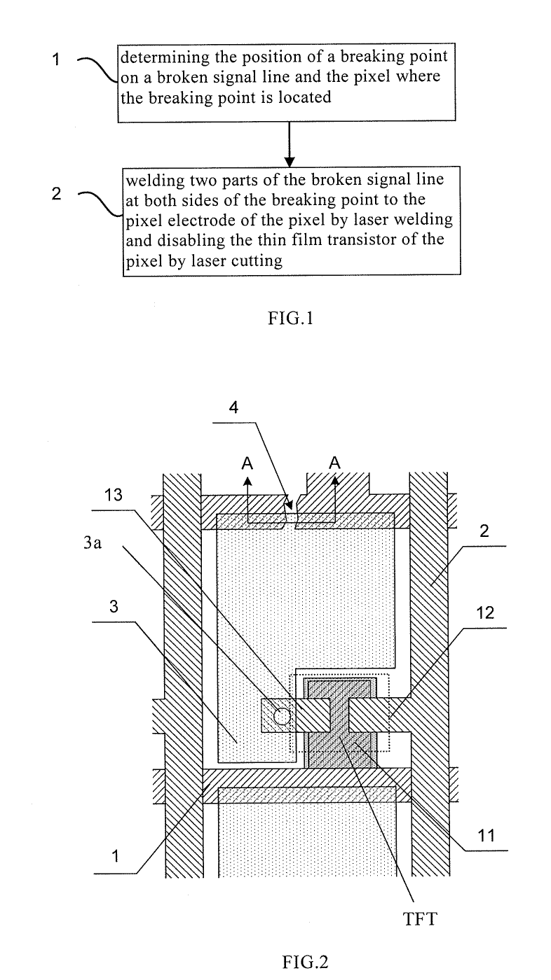

FIGS. 2 to 8 are schematic views showing a method for repairing broken lines of a LCD device according to a first exemplary embodiment of the invention.

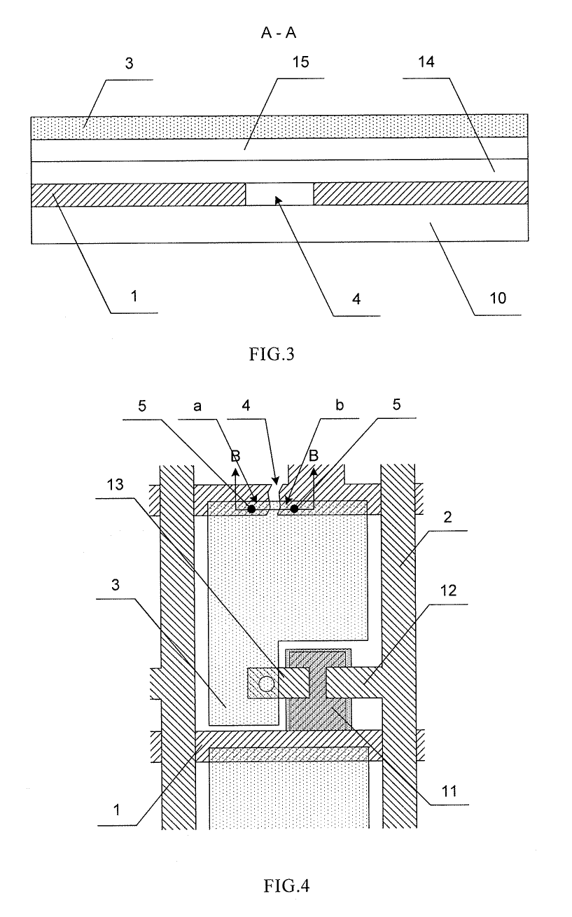

The LCD device is a thin film transistor liquid crystal display (TFT-LCD) device and has an array substrate with a typical pixel structure in which a storage capacitance is provided with a gate line. The array substrate of the present embodiment comprises a plurality of gate lines 1, a plurality of data lines 2, pixel electrodes 3, and thin film transistors (TFTs) as switching devices. The gate lines 1 and the data lines 2 intersect with each other to define pixel regions, and one thin film transistor is disposed at the intersection for each pixel region. The pixel electrode 3 is formed in each the pixel regions. The pixel electrode 3 overlaps one gate line 1 for the pixels in a previous row such that storage capacitance is generated therebetween. The TFT, as indicated with a dot line block in FIG. 2, includes at least a gate electrode 11 formed on a substrate 10, and a source electrode 12 and a drain electrode 13 disposed above the gate electrode 11. The gate electrode 11 is connected to the gate line 1, the source electrode is connected to the data line 2, and the drain electrode 13 is connected to the pixel electrode 3 by a via hole 3a through a passivation layer 15. If a gate line breaking failure is detected in a testing step after the cell process, the position of the breaking point on the gate line and the pixel where the breaking point is located are to be determined. FIG. 2 is a schematic view showing a gate line breaking failure in the first exemplary embodiment of the invention; and FIG. 3 is a sectional view taken along a line A-A in FIG. 2. The breaking point 4 is on the gate line 1 of the array substrate, resulting in a bright or dark line defect corresponding to the gate line 1. The CVD bridging method can not be used to repair the failure because the array substrate and the color filter substrate have been attached to each other. FIG. 4 is a schematic view showing welding points according to the first exemplary embodiment of the invention; and FIG. 5 is a sectional view taken along a line B-B in FIG. 4. After having determined the position of the breaking point 4 on the gate line 1 and the pixel where the breaking point is located, a laser irradiated from the array substrate side may be used to weld the pixel electrode 3 to a part of the gate line 1 on one side of the breaking point 4 at a position “a” and to weld the pixel electrode 3 to the other part of the gate line 1 on the other side of the breaking point 4 at a position “b”, as shown in FIG. 4. Thus, the two parts of the gate line 1 on both sides of the breaking point 4 are connected with each other through two welding points 5 and the pixel electrode 3. The laser welding process utilizes heat generated from laser to melt the gate line 1 and form a via hole 3b in a gate insulating layer 14 and the passivation layer 15 between the gate line 1 and the pixel electrode 3. The melted gate line 1 is connected to the melted pixel electrode 3 through the via hole 3b, as shown in FIG. 5.

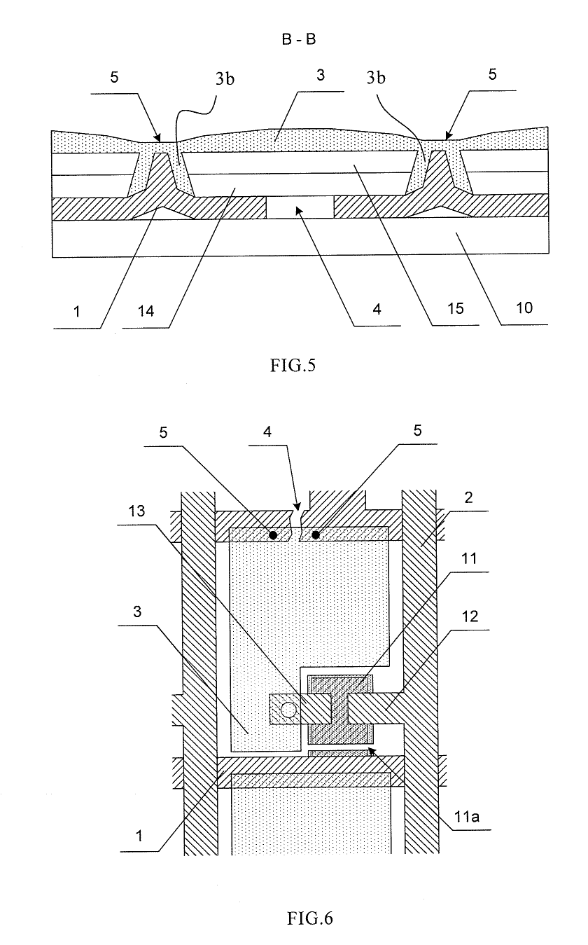

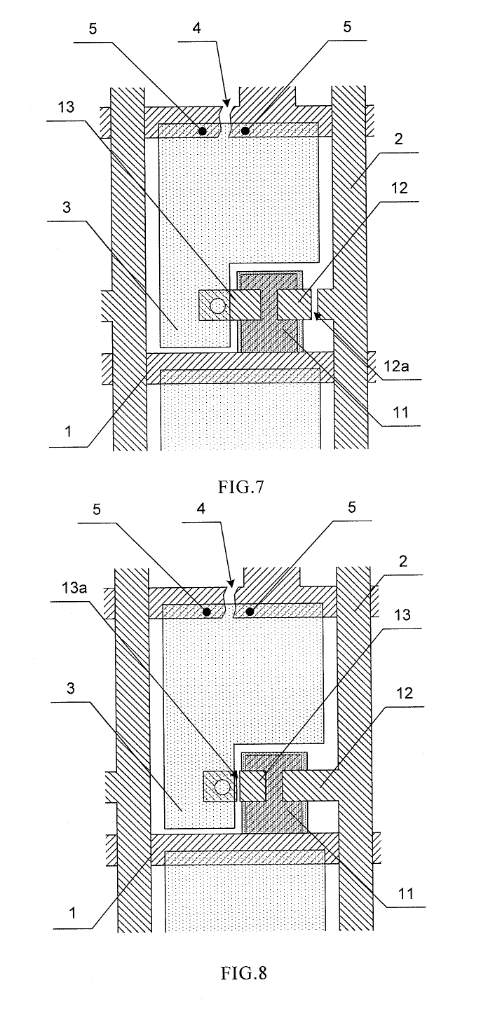

Then, laser cutting is performed from the array substrate side to disable the TFT of the determined pixel where the breaking point is located. FIGS. 6-8 are schematic views each showing a disabled TFT according to the first exemplary embodiment of the invention. As shown in FIG. 6, a gate electrode cutout 11a is formed to cut off the connection between the gate electrode 11 and the gate line 1 to which the gate electrode 11 is originally connected. As shown in FIG. 7, a source electrode cutout 12a is formed to cut off the connection between the source electrode 12 and the data line 2. As shown in FIG. 8, a drain electrode cutout 13a is formed to cut off the connection between the drain electrode 13 and the pixel electrode 3. Any one of the gate electrode cutout 11a, the source electrode cutout 12a and the drain electrode cutout 1 3a can make the TFT of the pixel fail to function. Since the pixel electrode 3 serves as a conductive layer to connect the parts of the broken gate line 1 and can not display image properly, the TFT of the pixel is disabled by cutting off at least one of the gate electrode 11, the source electrode 12, and the drain electrode 13. In this case, the pixel becomes a bright spot in a normal white mode or a dark spot in a normal black mode.

Alternatively, the laser cutting process may be performed before the laser welding process.

Differing from the CVD bridging method, the present embodiment repairs broken lines by utilizing a pixel electrode as a conductive layer for connecting the broken gate line by using laser welding and laser cutting. The gate line breaking failure is repaired such that it becomes a pixel failure. That is, a bright or dark line may be repaired to be a bright or dark spot. Thus, quality of the defective LCD device is improved. The method for repairing broken lines according to the present embodiment can efficiently reduce the cost.

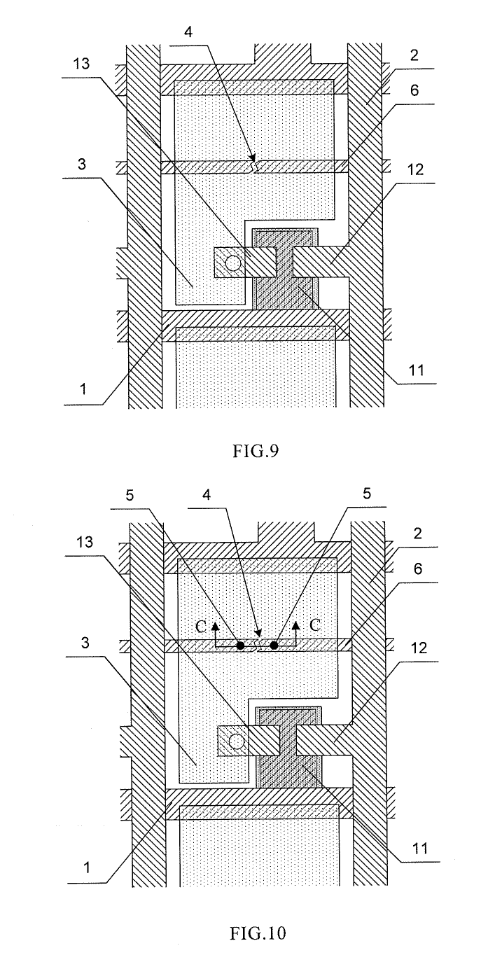

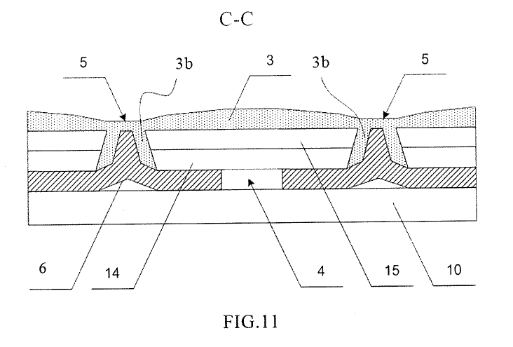

FIGS. 9-10 are schematic views showing a method for repairing broken lines according to a second exemplary embodiment of the invention. The LCD device is a TFT liquid crystal display (TFT-LCD) device and has an array substrate and a typical pixel structure in which a storage capacitance is provided on a storage electrode line. The array substrate of the present embodiment comprises a gate line 1, a storage electrode line 6, a data line 2, a pixel electrode 3, and a TFT as a switching device. The gate line 1 and the data line 2 intersect with each other to define a pixel region, and the TFT is disposed near the intersection of the pixel region. The pixel electrode 3 is formed in the pixel region and overlaps the storage electrode line 6 to provide storage capacitance therebetween. The TFT includes at least a gate electrode 11 formed on the substrate 10, and a source electrode 12 and a drain electrode 13 disposed above the gate electrode 11. The gate electrode 11 is connected to the gate line 1, the source electrode 12 is connected to the data line 2, and the drain electrode 13 is connected to the pixel electrode 3 by a via hole 3a through a passivation layer 15. If a storage electrode line breaking failure is detected in a testing step after the cell process, the position of the breaking point on the storage electrode line and the pixel where the breaking point is located is determined. FIG. 9 is a schematic view showing a storage electrode line breaking failure in the second exemplary embodiment of the invention. The breaking point 4 occurs on the storage electrode line 6 of the array substrate, resulting in a line failure corresponding to the storage electrode line 6. The CVD bridging method can not be used to repair the failure because the array substrate and the color filter substrate have been attached to each other. FIG. 10 is a schematic view showing welding points according to the second exemplary embodiment of the invention. After having determined the position of the breaking point 4 on the storage electrode line 6 and the pixel where the breaking point 4 is located, a laser irradiated from the array substrate side may be used to weld the pixel electrode 3 to a part of the storage electrode line 6 on one side of the breaking point 4 at a position “a” and to weld the pixel electrode 3 to the other part of the storage electrode line 6 on the other side of the breaking point 4 at a position “b.” Thus, two parts of the storage electrode line 6 on both sides of the breaking point 4 are connected with each other through two welding points 5 and the pixel electrode 3. The laser welding process utilizes heat generated from laser to melt the storage electrode line 6 and form a via hole 3b in a gate insulating layer 14 and the passivation layer 15 between the storage electrode line 6 and the pixel electrode 3. The melted storage electrode line 6 is connected to the melted pixel electrode 3 through the via hole 3b. The structure formed after the laser welding according to the present embodiment is similar to that shown in FIG. 11.

Then, laser cutting may be performed from the array substrate side to disable the TFT of the determined pixel where the breaking point is located. The TFT may be disabled by at least one of forming a gate electrode cutout to cut off the connection between the gate electrode 11 and the gate line 1 to which the gate electrode 11 is originally connected, forming a source electrode cutout to cut off the connection between the source electrode 12 and the data line 2, and forming a drain electrode cutout to cut off the connection between the drain electrode 13 and the pixel electrode 3. The gate electrode cutout, the source electrode cutout, and the drain electrode cutout may be provided in a manner similar to that shown in FIGS. 6-8, and any one of them can make the TFT of the pixel fail to function. Since the pixel electrode 3 in the pixel where the breaking point is located serves as a conductive layer to connect parts of the broken storage electrode line 6 and can not display image properly, the TFT of the pixel is disabled by cutting off at least one of the gate electrode 11, the source electrode 12 and the drain electrode 13. In this case, the pixel where the breaking point is located becomes a bright spot in a normal white mode or a dark spot in a normal black mode.

Alternatively, the laser cutting process may be performed before the laser welding process.

Differing from the CVD bridging method, the present embodiment repairs broken storage electrode lines by utilizing a pixel electrode as a conductive layer for connecting the parts of the broken lines by using laser welding and laser cutting. The storage electrode line breaking failure is repaired such that it becomes a pixel failure. That is, a bright (or weakly bright) or dark (or lightly dark) line is transformed into a bright (or weakly bright) or dark (or lightly dark) spot. Thus, quality of the defective LCD device is improved. The method for repairing broken lines according to the present embodiment can efficiently reduce the cost.

It should be noted that the invention may also be applied during the array process before the cell process, especially at the end of the array process, so as to repair broken gate lines and broken storage electrode lines.

An embodiment of the invention further provides a LCD device comprising an array substrate and a color filter substrate facing each other with a liquid crystal layer interposed therebetween. The array substrate includes gate lines, data lines, pixel electrodes and TFTs formed thereon. The gate lines intersect the data lines to define pixel regions in which the pixel electrodes are formed. Each of the TFTs is disposed near a intersection between one of the gate lines and one of the data lines and includes at least a gate electrode connected to the gate line, a source electrode connected to the data line, and a drain electrode connected to the pixel electrode through a via hole in a passivation layer. Among the plurality of pixel regions of the array substrate, at least one pixel region is a repair region where a signal line breaking failure (e.g., a gate line breaking failure or a storage electrode line breaking failure) is repaired such that it becomes a pixel failure. Specifically, the repair region includes a pixel electrode used as a conductive layer to connect two parts of the broken signal line at both sides of the breaking point, and a disabled TFT. At least two welding points are formed on the pixel electrode. At least one welding point is positioned at one side of the breaking point and welds a part of the broken signal line at said side of the breaking point to the pixel electrode, and at least another welding point is positioned at the other side of the breaking point and welds the other part of the broken signal line at the other side of the breaking point to the pixel electrode, such that two parts of the broken signal line at both side of the breaking point are connected with each other through the welding points and the pixel electrode.

The disabled TFT includes at least a gate electrode, a source electrode and a drain electrode. The gate electrode may have a cutout formed thereon to cut off the connection between the gate electrode and the gate line; the source electrode may have a cutout formed thereon to cut off the connection between the source electrode and the data line; and the drain electrode may have a cutout formed thereon to cut off the connection between the drain electrode and the pixel electrode. The LCD device according to the embodiment of the invention has been described in the first and second exemplary embodiments, and the detailed description thereof is not repeated here.

The invention being thus described, it will be obvious that the same may be varied in many ways. Such variations are not to be regarded as a departure from the spirit and scope of the invention, and all such modifications as would be obvious to those skilled in the art are intended to be included within the scope of the following claims.

What is claimed is:

1. A method for repairing a broken signal line of a liquid crystal display device, comprising:
determining a position of a breaking point on the broken signal line and a pixel where the breaking point is located on an array substrate; and
welding two parts of the broken signal line at both sides of the breaking point to a pixel electrode of the pixel by laser welding and disabling a thin film transistor as a switching device of the pixel by laser cutting.

2. The method according to claim 1, wherein the step of disabling a thin film transistor of the pixel by laser cutting comprises:
using laser irradiated from the array substrate side to form a cutout in a gate electrode of the thin film transistor such that the gate electrode is disconnected from a gate line to which the gate electrode is originally connected.

3. The method according to claim 1, wherein the step of disabling a thin film transistor of the pixel by laser cutting comprises:
using laser irradiated from the array substrate side to form a cutout in a source electrode of the thin film transistor such that the source electrode is disconnected from a data line to which the source electrode is originally connected.

4. The method according to claim 1, wherein the step of disabling a thin film transistor of the pixel by laser cutting comprises:
using laser irradiated from the array substrate side to form a cutout in a drain electrode of the thin film transistor such that the drain electrode is disconnected from the pixel electrode.

5. The method according to claim 1, wherein the broken signal line is a gate line or a storage electrode line.

6. The method according to claim 5, wherein the step of disabling a thin film transistor of the pixel by laser cutting comprises:
using laser irradiated from the array substrate side to form a cutout in a gate electrode of the thin film transistor such that the gate electrode is disconnected from a gate line to which the gate electrode is originally connected.

7. The method according to claim 5, wherein the step of disabling a thin film transistor of the pixel by laser cutting comprises:
using laser irradiated from the array substrate side to form a cutout in a source electrode of the thin film transistor such that the source electrode is disconnected from a data line to which the source electrode is originally connected.

8. The method according to claim 5, wherein the step of disabling a thin film transistor of the pixel by laser cutting comprises:
using laser irradiated from the array substrate side to form a cutout in a drain electrode of the thin film transistor such that the drain electrode is disconnected from the pixel electrode.

9. The method according to claim 1, wherein the step of welding two parts of the broken signal line at both sides of the breaking point to the pixel electrode of the pixel by laser welding comprises:
using laser irradiated from the array substrate side to weld one part of the broken signal line at one side of the breaking point to the pixel electrode to form a welding point, and weld the other part of the broken signal line at the other side of the breaking point to the pixel electrode to form another welding point, such that said two parts of the broken signal line at both sides of the breaking point are connected with each other through the two welding points and the pixel electrode.

10. The method according to claim 9, wherein the broken signal line is a gate line or a storage electrode line.

11. The method according to claim 9, wherein the step of disabling a thin film transistor of the pixel by laser cutting comprises:
using laser irradiated from the array substrate side to form a cutout in a gate electrode of the thin film transistor such that the gate electrode is disconnected from a gate line to which the gate electrode is originally connected.

12. The method according to claim 9, wherein the step of disabling a thin film transistor of the pixel by laser cutting comprises:
using laser irradiated from the array substrate side to form a cutout in a source electrode of the thin film transistor such that the source electrode is disconnected from a data line to which the source electrode is originally connected.

13. The method according to claim 9, wherein the step of disabling a thin film transistor of the pixel by laser cutting comprises:
using laser irradiated from the array substrate side to form a cutout in a drain electrode of the thin film transistor such that the drain electrode is disconnected from the pixel electrode.

14. A liquid crystal display device comprising an array substrate and a color filter substrate facing each other with a liquid crystal layer therebetween, the array substrate including a plurality of pixel regions defined by gate lines and data lines intersecting with each other, each pixel region including a pixel electrode and a thin film transistor as a switching device,
wherein at least one pixel region is a repair region where a signal line breaking failure is repaired to become a pixel failure.

15. The liquid crystal display device according to claim 14, wherein the pixel electrode in the pixel region as the repair region serves as a conductive layer to connect parts of a broken signal line causing the signal line breaking failure, and the thin film transistor in the pixel region as the repair region is disabled.

16. The liquid crystal display device according to claim 15, wherein the pixel electrode in the pixel region as the repair region has at least two welding points formed thereon, at least one of which is positioned at one side of the breaking point and welds a part of the broken signal line at said side of the breaking point to the pixel electrode, and at least another one of which is positioned at the other side of the breaking point and welds the other part of the broken signal line at the other side of the breaking point to the pixel electrode, thereby two parts of the broken signal line at both side of the breaking point are connected with each other through the at least two welding points and the pixel electrode.

17. The liquid crystal display device according to claim 15, wherein the disabled thin film transistor includes at least a gate electrode, a source electrode and a drain electrode, and the thin film transistor is disabled by at least one of a cutout formed on the gate electrode to cut off the connection between the gate electrode and the gate line to which the gate electrode is originally connected, a cutout formed on the gate electrode to cut off the connection between the source electrode and the data line, and a cutout formed on the gate electrode to cut off the connection between the drain electrode and the pixel electrode.

18. The liquid crystal display device according to claim 14, wherein the broken signal line is a gate line or a storage electrode line.
